(19) United States
(12) Patent Application Publication
(10) Pub. No.: US 2026/0270983 A1
(43) Pub. Date: Sep. 10, 2026

(54) EMLSR SST OPERATIONS IN WIRELESS COMMUNICATIONS

(71) Applicant: MEDIATEK INC., Hsinchu City (TW)

(72) Inventors: Yongho SEOK, San Jose, CA (US); James Chih-Shi YEE, San Jose, CA (US); Kai Ying LU, San Jose, CA (US)

(21) Appl. No.: 19/167,720

(22) PCT Filed: Aug. 9, 2024
(86) PCT No.: PCT/CN2024/111157

§ 371 Date: Sep. 22, 2025

Related U.S. Application Data
(60) Provisional application No. 63/518,571, filed on Aug. 10, 2023.

(51) Int. Cl. H04W 72/1263; H04W 74/0816

(52) U.S. Cl. CPC H04W 72/1263; H04W 74/0816

(57) ABSTRACT

Various schemes pertaining to enhanced multi-link single-radio (EMLSR) selective subchannel transmission (SST) operations in wireless communications are described. A non-access point (non-AP) station (STA) affiliated with a non-AP multi-link device (MLD) transmits a first frame with information of a preferred SST channel to an access point (AP) affiliated with an AP MLD. In response, the non-AP STA receives a second frame with information of a negotiated SST channel from the AP. The non-AP STA then performs an EMLSR SST operation with the AP by communicating on the negotiated SST channel.

### CROSS REFERENCE TO RELATED PATENT APPLICATION

The present disclosure is part of a non-provisional patent application claiming the priority benefit of U.S. Provisional Patent Application No. 63/518,571, filed 10 Aug. 2023, the content of which being incorporated by reference in its entirety.

### TECHNICAL FIELD

The present disclosure is generally related to wireless communications and, more particularly, to enhanced multi-link single-radio (EMLSR) selective subchannel transmission (SST) operations in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) and wireless local area networks (WLANs) in accordance with one or more Institute of Electrical and Electronics Engineers (IEEE) 802.11 standards, a new method of dynamic subband operation may be defined for ultra-high-reliability (UHR) communications to allow a 320 MHz access point (AP) to dynamically indicate to a 160 MHz non-AP station (STA) a transmission (Tx) and/or receiving (Rx) opportunity on a secondary 160 MHz frequency segment. The operation may be downlink (DL) or trigger-based (TB) uplink (UL) inside each dynamically allocated opportunity. The dynamic subband operation can enable the AP to utilize its secondary 160 MHz bandwidth in a dynamic manner on a per-transmission opportunity (per-TXOP) basis whenever the AP wins channel access on the secondary 160 MHz bandwidth. For instance, the AP can dynamically decide whether to allocate non-APs on the primary 160 MHz or secondary 160 MHz and which non-APs to allocate in this manner depending on bandwidth availability, channel conditions and quality of service (QOS) requirements. This helps align the presence of narrower-bandwidth non-APs on the secondary 160 MHz channel with availability of the secondary 160 MHz bandwidth. Consequently, this results in better resource utilization and system performance compared to high-efficiency (HE) SST.

On the other hand, SST tends to have several limitations. For example, there is no guarantee regarding the AP winning channel access on the secondary 160 MHz channel during predefined semi-static service periods (SPs). If this happens, the AP would not be able to schedule SST non-APs that move to the secondary 160 MHz during an SP. This would happen even if the AP, on winning the primary 160 MHz during the same SP, has spare bandwidth within the primary 160 MHz to allocate to these SST non-APs. However, this tends to not only render the AP scheduler limited and sub-optimal, but also wastes bandwidth resources. The converse can also occur. That is, the AP may win access on the secondary 160 MHz channel outside the semi-static SPs but cannot schedule any SST non-APs within it. Even if the AP wins channel access on the secondary 160 MHz channel during the SPs, there may not be any DL/UL buffered data for the SST non-APs during the SPs while data may arrive later outside the SPs when all non-APs are present on the primary 160 MHz. Thus, it would be beneficial to enable EMLSR SST operations that support dynamic subband operation by combining the merits of SST and EMLSR. Therefore, there is a need for a solution of EMLSR SST operations in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to EMLSR SST operations in wireless communications. It is believed that implementations of the proposed schemes may address or otherwise alleviate aforementioned issues. An EMLSR operation already supports a subchannel switching function within a single transmission opportunity (TXOP). By defining an SST operation on top of EMLSR, channel utilization of a wide band (e.g., 320 MHz or 640 MHz) basic service set (BSS) may be improved (e.g., in terms of reduced latency and enhanced throughput).

In one aspect, a method may involve a non-AP STA affiliated with a non-AP multi-link device (MLD) transmitting a first frame with information of a preferred SST channel to an AP affiliated with an AP MLD. The method may also involve the non-AP STA receiving a second frame with information of a negotiated SST channel from the AP responsive to transmitting the first frame.

In another aspect, a method may involve an AP affiliated with an AP MLD requesting a non-AP STA affiliated with a non-AP MLD to switch to a negotiated SST channel. The method may also involve the AP performing an EMLSR SST operation with the non-AP STA by communicating on the negotiated SST channel.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a block diagram of an example communication system under a proposed scheme in accordance with the present disclosure.

FIG. 6 is a flowchart of an example process under a proposed scheme in accordance with the present disclosure.

FIG. 7 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to EMLSR SST operations in wireless communications. According to the present disclosure, a number of possible solutions may be implemented separately or jointly. That is, although these possible solutions may be described below separately, two or more of these possible solutions may be implemented in one combination or another.

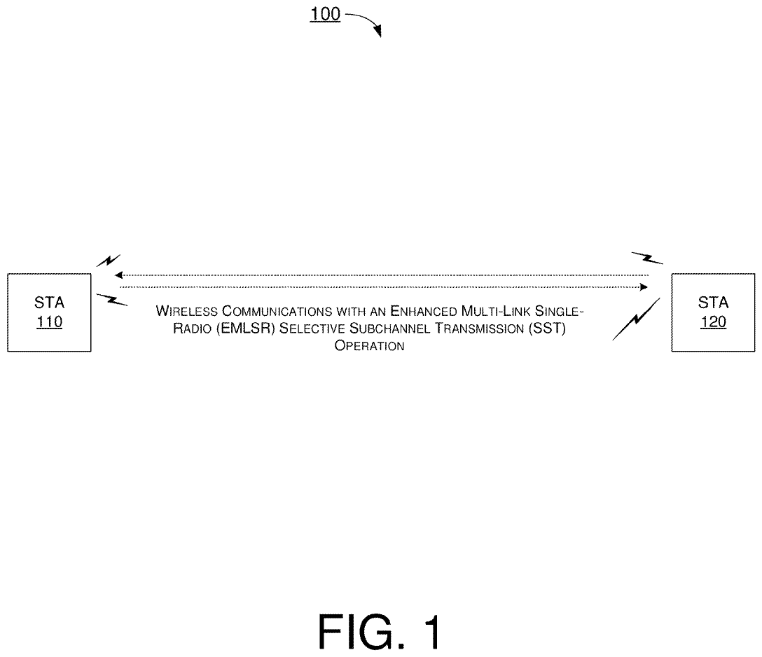

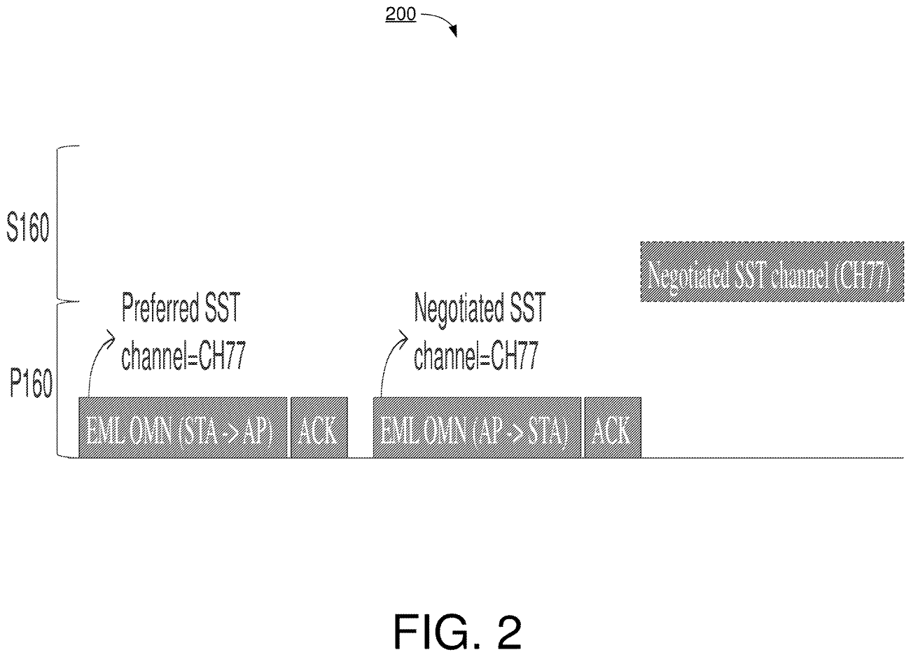

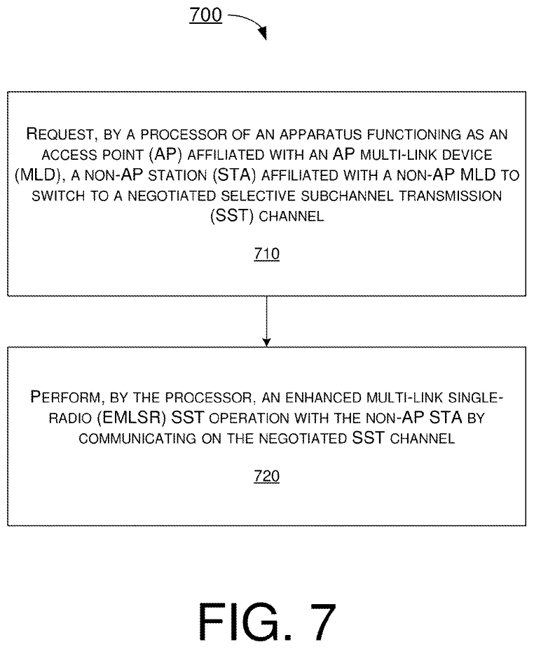

FIG. 1 illustrates an example network environment 100 in which various solutions and schemes in accordance with the present disclosure may be implemented. FIG. 2~FIG. 7 illustrate examples of implementation of various proposed schemes in network environment 100 in accordance with the present disclosure. The following description of various proposed schemes is provided with reference to FIG. 1~FIG. 7.

Referring to FIG. 1, network environment 100 may involve at least a communication entity 110 communicating wirelessly with a communication entity 120. Either of communication entity 110 and communication entity 120 may function as an AP STA or, alternatively, a non-AP STA. Each of communication entity 110 and communication entity 120 may be a multi-link device (MLD). In some cases, communication entity 110 (herein interchangeably referred to as “STA 110”) and communication entity 120 (herein interchangeably referred to as “STA 120”) may be associated with a BSS in accordance with one or more IEEE 802.11 standards (e.g., IEEE 802.11be and/or future-developed standards such as IEEE 802.11bn). Each of communication entity 110 and communication entity 120 may be configured to communicate with each other by utilizing the EMLSR SST operations in accordance with various proposed schemes described below. That is, either or both of communication entity 110 and communication entity 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 under a proposed scheme in accordance with the present disclosure. Under the proposed scheme, a non-AP STA (e.g., STA 110) affiliated with a non-AP MLD (e.g., STA 110) may transmit an enhanced multi-link (EML) operating mode notification (OMN) frame with information of a preferred SST channel to an AP (e.g., STA 120) affiliated with its associated AP MLD (e.g., to Indicate its preferred subbands/subchannels on each link of multiple links). The SST channel information may be encoded into a bitmap (e.g., with each bit of the bitmap representing a respective 20 MHz subchannel of a plurality of 20 MHz subchannels within the BSS bandwidth).

Under the proposed scheme, an AP affiliated with an AP MLD may transmit an EML OMN frame with information of a negotiated SST channel, as a response to the received EML OMN frame, to the non-AP STA affiliated with the non-AP MLD (e.g., to indicate one or more configured subbands/subchannels on each link of the multiple links). Similarly, the SST channel information may be encoded into a bitmap (e.g., with each bit of the bitmap representing a respective 20 MHz subchannel of the plurality of 20 MHz subchannels within the BSS bandwidth).

In the example shown in FIG. 2, the EML OMN frame transmitted by the non-AP STA to the AP may indicate that its preferred SST channel is channel 77. Correspondingly, in the response EML OMN frame transmitted by the AP to the non-AP STA, the AP may indicate that the negotiated SST channel is channel 77.

Under a proposed scheme in accordance with the present disclosure with respect to EMLSR SST operations, an AP MLD that initiates frame exchanges with a non-AP MLD may request to the non-AP MLD (e.g., an EMLSR non-AP MLD) to switch to the negotiated SST channel (which may be an EMLSR link) by setting the Resource Unit (RU) Allocation field in the initial Control frame (e.g., multi-user request-to-send (MU-RTS) and buffer status report poll (BSRP) Trigger frames) to the negotiated SST channel. After the initial Control frame exchange sequence, the AP STA MLD and non-AP MLD may follow the SST rule described below. That is, the non-AP MLD may stay at the switched SST channel until the end of the TXOP. To indicate the time required by the STA to switch between different subchannels, an EMLSR SST padding delay (e.g., a delay due to switching from one link to the indicated subband of another link) and an EMLSR SST transition delay (e.g., a delay due to switching back from the indicated subband of the other link to listening mode on an EMLSR link pair) may be signaled in the EML OMN frame.

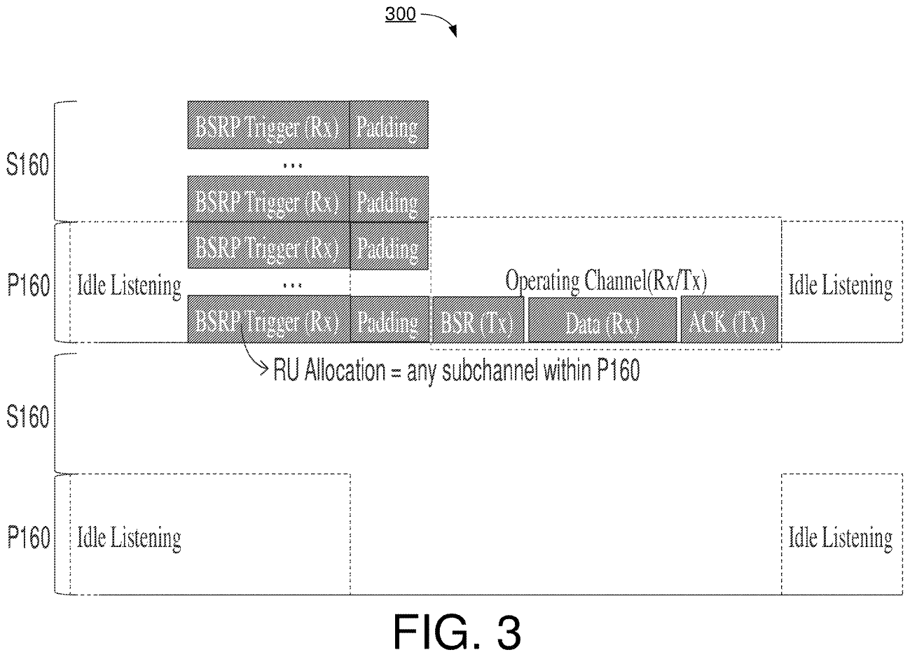

FIG. 3 illustrates an example scenario 300 under a proposed scheme in accordance with the present disclosure. Referring to FIG. 3, a non-AP STA affiliated with a non-AP MLD (e.g., STA 110) may receive, from an AP affiliated with an AP MLD (e.g., STA 120), a BSRP trigger frame (followed by a padding) on each link of multiple links in a primary 160 MHz band. The RU Allocation field in the BSRP trigger frame may indicate any subchannel within the primary 160 MHz as the operating channel. In response, the non-AP STA may engage in an EMLSR SST operation with the AP by transmitting a BSR on the operating channel, receiving data on the operating channel, and transmitting an acknowledgement (ACK) on the operating channel.

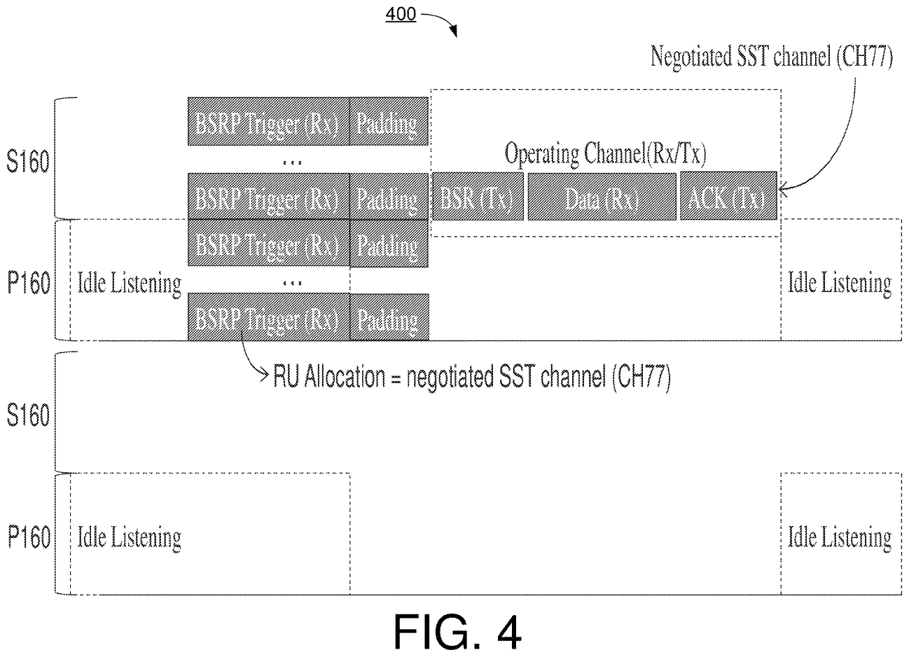

FIG. 4 illustrates an example scenario 400 under a proposed scheme in accordance with the present disclosure. Referring to FIG. 4, a non-AP STA affiliated with a non-AP MLD (e.g., STA 110) may receive, from an AP affiliated with an AP MLD (e.g., STA 120), a BSRP trigger frame (followed by a padding) on each link of multiple links in a primary 160 MHz band. The RU Allocation field in the BSRP trigger frame may indicate channel 77 within the secondary 160 MHz as the negotiated SST channel. In response, the non-AP STA may engage in an EMLSR SST operation with the AP by transmitting a BSR on channel 77, receiving data on channel 77, and transmitting an ACK on channel 77.

### Illustrative Implementations

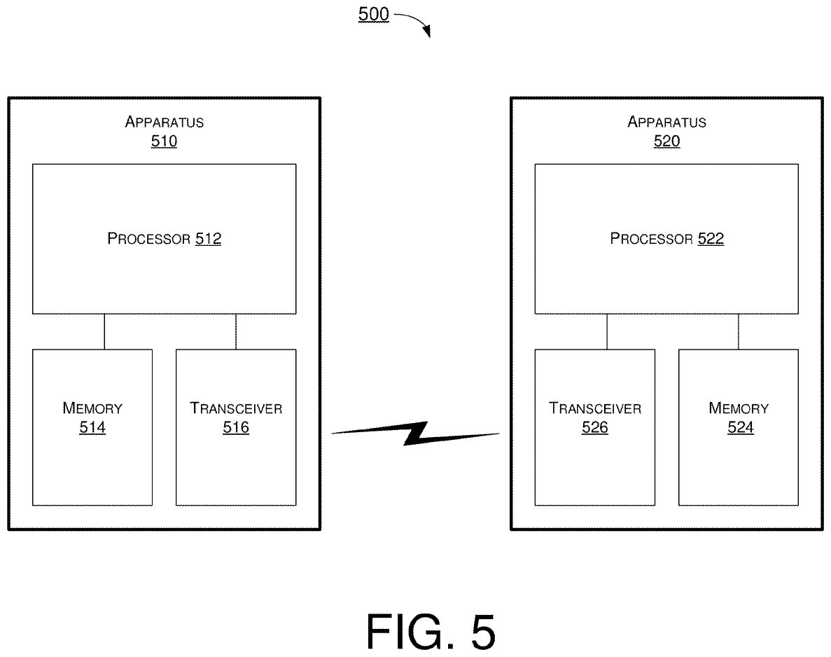

FIG. 5 illustrates an example system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to EMLSR SST operations in wireless communications, including the various schemes described above with respect to various proposed designs, concepts, schemes, systems and methods described above as well as processes described below. For instance, apparatus 510 may be an example implementation of a non-AP STA affiliated with a non-AP MLD (e.g., STA 110), and apparatus 520 may be an example implementation of an AP affiliated with an AP MLD (e.g., STA 120).

Each of apparatus 510 and apparatus 520 may be a part of an electronic apparatus, which may be a STA or an AP, such as a portable or mobile apparatus, a wearable apparatus, a wireless communication apparatus or a computing apparatus. For instance, each of apparatus 510 and apparatus 520 may be implemented in a smartphone, a smart watch, a personal digital assistant, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in a network node, such as an AP in a WLAN.

In some implementations, each of apparatus 510 and apparatus 520 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 510 and apparatus 520 may be implemented in or as a STA or an AP. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, one or more RISC processors or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to EMLSR SST operations in wireless communications in accordance with various implementations of the present disclosure. For instance, each of processor 512 and processor 522 may be configured with hardware components, or circuitry, implementing one, some or all of the examples described and illustrated herein.

In some implementations, apparatus 510 may also include a transceiver 516 coupled to processor 512. Transceiver 516 may be capable of wirelessly transmitting and receiving data. In some implementations, apparatus 520 may also include a transceiver 526 coupled to processor 522. Transceiver 526 may include a transceiver capable of wirelessly transmitting and receiving data.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of apparatus 510 and apparatus 520 may be a communication entity capable of communicating with each other using various proposed schemes in accordance with the present disclosure. For illustrative purposes and without limitation, a description of capabilities of apparatus 510, as a sharing AP (e.g., AP₁), and apparatus 520, as a shared AP (e.g., AP₂), is provided below in the context of example processes 600 and 700. It is noteworthy that, although the example implementations described below are provided in the context of WLAN, the same may be implemented in other types of networks. Thus, although the following description of example implementations pertains to a scenario in which apparatus 510 functions as a transmitting device and apparatus 520 functions as a receiving device, the same is also applicable to another scenario in which apparatus 510 functions as a receiving device and apparatus 520 functions as a transmitting device.

### Illustrative Processes

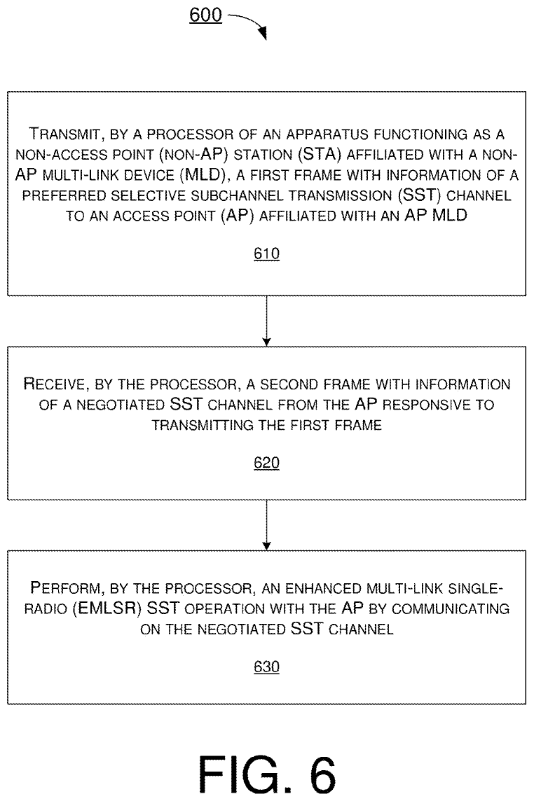

FIG. 6 illustrates an example process 600 in accordance with an implementation of the present disclosure. Process 600 may represent an aspect of implementing various proposed designs, concepts, schemes, systems and methods described above. More specifically, process 600 may represent an aspect of the proposed concepts and schemes pertaining to EMLSR SST operations in wireless communications in accordance with the present disclosure. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively, in a different order. Furthermore, one or more of the blocks/sub-blocks of process 600 may be executed repeatedly or iteratively. Process 600 may be implemented by or in apparatus 510 and apparatus 520 as well as any variations thereof. Solely for illustrative purposes and without limiting the scope, process 600 is described below in the context of apparatus 510 as a non-AP STA affiliated with a non-AP MLD (e.g., STA 110) and apparatus 520 as an AP affiliated with an AP MLD (e.g., STA 120) of a wireless network in accordance with one or more of IEEE 802.11 standards. Process 600 may begin at block 610.

At 610, process 600 may involve processor 512 of apparatus 510 transmitting, via transceiver 516, a first frame with information of a preferred SST channel to an AP affiliated with an AP MLD (e.g., apparatus 520). Process 600 may proceed from 610 to 620.

At 620, process 600 may involve processor 512 receiving, via transceiver 516, a second frame with information of a negotiated SST channel from the AP responsive to transmitting the first frame. Process 600 may proceed from 620 to 630.

At 630, process 600 may involve processor 512 performing, via transceiver 516, an EMLSR SST operation with the AP by communicating on the negotiated SST channel.

In some implementations, the information of the preferred SST channel may indicate one or more preferred subbands or subchannels on each link of multiple links.

In some implementations, the information of the preferred SST channel may be encoded in a bitmap with each bit of the bitmap representing a respective 20 MHz subchannel of a plurality of 20 MHz subchannels within a BSS bandwidth.

In some implementations, the information of the negotiated SST channel may indicate one or more configured subbands or subchannels on each link of multiple links.

In some implementations, the information of the negotiated SST channel may be encoded in a bitmap with each bit of the bitmap representing a respective 20 MHz subchannel of a plurality of 20 MHz subchannels within a BSS bandwidth.

In some implementations, at least one of the first frame and the second frame may include an EML OMN frame.

FIG. 7 illustrates an example process 700 in accordance with an implementation of the present disclosure. Process 700 may represent an aspect of implementing various proposed designs, concepts, schemes, systems and methods described above. More specifically, process 700 may represent an aspect of the proposed concepts and schemes pertaining to EMLSR SST operations in wireless communications in accordance with the present disclosure. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively, in a different order. Furthermore, one or more of the blocks/sub-blocks of process 700 may be executed repeatedly or iteratively. Process 700 may be implemented by or in apparatus 510 and apparatus 520 as well as any variations thereof. Solely for illustrative purposes and without limiting the scope, process 700 is described below in the context of apparatus 510 as a non-AP STA affiliated with a non-AP MLD (e.g., STA 110) and apparatus 520 as an AP affiliated with an AP MLD (e.g., STA 120) of a wireless network in accordance with one or more of IEEE 802.11 standards. Process 700 may begin at block 710.

At 710, process 700 may involve processor 522 of apparatus 520 requesting, via transceiver 526, a non-AP STA affiliated with a non-AP MLD (e.g., apparatus 510) to switch to a negotiated SST channel. Process 700 may proceed from 710 to 720.

At 720, process 700 may involve processor 522 performing, via transceiver 526, an EMLSR SST operation with the non-AP STA by communicating on the negotiated SST channel.

In some implementations, the negotiated SST channel may include an SST subchannel of an EMLSR link.

In some implementations, in requesting, process 700 may involve processor 522 transmitting a control frame with a RU Allocation field indicating the negotiated SST channel. In some implementations, the control frame may include an MU-RTS frame or a BSRP trigger frame.

In some implementations, in performing the EMLSR SST operation, process 700 may involve processor 522 receiving, from the non-AP STA, an EML OMN frame indicating a time required by the non-AP STA to switch between different subchannels. In some implementations, the time required by the non-AP STA to switch between different subchannels may include an EMLSR SST padding delay as a delay due to switching from one link to an indicated subband of one other link. In some implementations, the time required by the non-AP STA to switch between different subchannels may further include an EMLSR SST transition delay as a delay due to switching back from the indicated subband of the other link to a listening mode on an EMLSR link pair.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus functioning as a non-access point (non-AP) station (STA) affiliated with a non-AP multi-link device (MLD), a first frame with information of a preferred selective subchannel transmission (SST) channel to an access point (AP) affiliated with an AP MLD; and
receiving, by the processor, a second frame with information of a negotiated SST channel from the AP responsive to transmitting the first frame.

2. The method of claim 1, wherein the information of the preferred SST channel indicates one or more preferred subbands or subchannels on each link of multiple links.

3. The method of claim 1, wherein the information of the preferred SST channel is encoded in a bitmap with each bit of the bitmap representing a respective 20 MHz subchannel of a plurality of 20 MHz subchannels within a basic service set (BSS) bandwidth.

4. The method of claim 1, wherein the information of the negotiated SST channel indicates one or more configured subbands or subchannels on each link of multiple links.

5. The method of claim 1, wherein the information of the negotiated SST channel is encoded in a bitmap with each bit of the bitmap representing a respective 20 MHz subchannel of a plurality of 20 MHz subchannels within a basic service set (BSS) bandwidth.

6. The method of claim 1, wherein at least one of the first frame and the second frame comprises an enhanced multi-link (EML) operating mode notification (OMN) frame.

7. The method of claim 1, further comprising:
performing, by the processor, an enhanced multi-link single-radio (EMLSR) SST operation with the AP by communicating on the negotiated SST channel.

8. A method, comprising:
requesting, by a processor of an apparatus functioning as an access point (AP) affiliated with an AP multi-link device (MLD), a non-AP station (STA) affiliated with a non-AP MLD to switch to a negotiated selective subchannel transmission (SST) channel; and
performing, by the processor, an enhanced multi-link single-radio (EMLSR) SST operation with the non-AP STA by communicating on the negotiated SST channel.

9. The method of claim 8, wherein the negotiated SST channel comprises an SST subchannel of an EMLSR link.

10. The method of claim 8, wherein the requesting comprises transmitting a control frame with a resource unit (RU) allocation field indicating the negotiated SST channel.

11. The method of claim 10, wherein the control frame comprises a multi-user request-to-send (MU-RTS) frame or a buffer status report poll (BSRP) trigger frame.

12. The method of claim 8, wherein the performing of the EMLSR SST operation comprises receiving, from the non-AP STA, an enhanced multi-link (EML) operating mode notification (OMN) frame indicating a time required by the non-AP STA to switch between different subchannels.

13. The method of claim 12, wherein the time required by the non-AP STA to switch between different subchannels comprises an EMLSR SST padding delay as a delay due to switching from one link to an indicated subband of one other link.

14. The method of claim 13, wherein the time required by the non-AP STA to switch between different subchannels further comprises an EMLSR SST transition delay as a delay due to switching back from the indicated subband of the other link to a listening mode on an EMLSR link pair.

15. An apparatus implementable in a multi-link device (MLD), comprising:
a transceiver configured to transmit and receive wirelessly; and
a processor coupled to the transceiver and configured to perform, as a non-access point (non-AP) station (STA) affiliated with the MLD, operations comprising:
transmitting, via the transceiver, a first frame with information of a preferred selective subchannel transmission (SST) channel to an access point (AP) affiliated with an AP MLD;
receiving, via the transceiver, a second frame with information of a negotiated SST channel from the AP responsive to transmitting the first frame; and
performing, via the transceiver, an enhanced multi-link single-radio (EMLSR) SST operation with the AP by communicating on the negotiated SST channel.

16. The apparatus of claim 15, wherein the information of the preferred SST channel indicates one or more preferred subbands or subchannels on each link of multiple links.

17. The apparatus of claim 15, wherein the information of the preferred SST channel is encoded in a bitmap with each bit of the bitmap representing a respective 20 MHz subchannel of a plurality of 20 MHz subchannels within a basic service set (BSS) bandwidth.

18. The apparatus of claim 15, wherein the information of the negotiated SST channel indicates one or more configured subbands or subchannels on each link of multiple links.

19. The apparatus of claim 15, wherein the information of the negotiated SST channel is encoded in a bitmap with each bit of the bitmap representing a respective 20 MHz subchannel of a plurality of 20 MHz subchannels within a basic service set (BSS) bandwidth.

20. The apparatus of claim 15, wherein at least one of the first frame and the second frame comprises an enhanced multi-link (EML) operating mode notification (OMN) frame.
